(19) United States
(12) Patent Application Publication
(10) Pub. No.: US 2018/0031092 A1
(43) Pub. Date: Feb. 1, 2018

(54) LINEAR ACTUATING DRIVE AND METHOD FOR ASSEMBLING AN ACTUATING DRIVE

(71) Applicant: SCHAEFFLER TECHNOLOGIES AG & CO. KG, Herzogenaurach (DE)

(72) Inventors: Patrick DANIEL, Kirkel (DE); Peter HEIPT, St. Ingbert (DE)

(73) Assignee: SCHAEFFLER TECHNOLOGIES AG & CO. KG, Herzogenaurach (DE)

(21) Appl. No.: 15/553,501

(22) PCT Filed: Mar. 2, 2016
(86) PCT No.: PCT/DE2016/200114

§ 371 Date: Aug. 24, 2017

(30) Foreign Application Priority Data
Mar. 6, 2015 (DE) 10 2015 204 074.7

(51) Int. Cl. F16H 25/20; F16H 57/04; F16H 25/24

(52) U.S. Cl. CPC F16H 25/20; F16H 25/2418; F16H 57/04; F16H 2025/2075; F16H 2025/2037; F16H 2025/2031

(57) ABSTRACT

An actuating drive comprising a drive unit including a drive shaft. The actuating drive also includes a spindle drive that includes a spindle configured to be actuated by the drive shaft, a bearing unit arranged between the drive unit and a spindle drive, wherein the bearing unit is configured to support a shaft that is connected to the drive shaft and the spindle. The actuating drive further includes a first and second chamber, wherein the first and second chamber are separated by the bearing unit and formed inside a housing of the actuating drive.

### CROSS-REFERENCE TO RELATED APPLICATIONS

This application is the U.S. National Phase of PCT/DE2016/200114 filed Mar. 2, 2016, which claims priority to DE 102015204074.7 filed Mar. 6, 2015, the entire disclosures of which are incorporated by reference herein.

### TECHNICAL FIELD

The disclosure relates to a linear actuating drive, which comprises a spindle drive and a drive unit provided for its drive, especially in the form of an electric drive, wherein a bearing unit is arranged between the drive unit and the spindle drive. In addition, the disclosure relates to a method for installing such an actuating drive.

### BACKGROUND

For example, US 2011/0061481 discloses a generic actuating drive with a built-in motor. For bearing a spindle, this actuating drive comprises a two-row axial ball bearing, which is arranged in a sleeve-like bearing housing. A pivot bearing arrangement can be connected with the bearing housing. For this purpose, pot-shaped retaining elements, which are fastened to, or screwed in, the bearing housing can be coupled either with a slide bearing or firmly connected with a respective pin arranged transversely relative to the longitudinal direction of the spindle. With the use of multiple screws, the preload of the axial bearing can be adjusted.

DE 20 2010 004 265 U1 also discloses a spindle drive with an integrated drive motor. For example, this spindle drive can be used for adjusting photovoltaic modules or parabolic dish antennas. The spindle drive has a casing tube, which surrounds a spindle. A thrust tube and a protective cover are connected with a spindle of the well-known spindle drive, wherein the protective cover can be axially moved on the casing tube.

### SUMMARY

The present disclosure may be based on the objective of developing a linear, pivotable actuating drive with a spindle drive and associated motor arranged one behind the other in moving direction, which may help with mechanical stability, installation space requirements, in particular regarding the dimensions transverse to moving direction, and installation costs.

According to a first embodiment, the disclosure may include an actuating drive having the characteristics described herein, as well as by a method for installing an actuating drive described herein. Advantages and embodiments subsequently described in more detail in connection with the installation method apply in corresponding manner also to the device, i.e., the actuating drive, and vice versa.

The actuating drive may include a housing, in which mechanical and electrical components are arranged. This may include a drive unit, especially in the form of an electric motor, including drive shaft, a spindle drive, which can be actuated by means of the drive unit and which is positioned coaxially to the drive unit, as well as a bearing unit, which is arranged between the drive unit and the spindle drive.

The spindle of the spindle drive is coupled in torque-proof manner with the drive shaft, wherein a shaft used to perform the coupling is supported in the bearing unit by a roller bearing and/or slide bearing. The shaft can involve the drive shaft, the spindle, or a separate intermediate shaft coupled with the drive shaft and the spindle. If the bearing accommodated in the bearing block involves a roller bearing said bearing is designed, for example, in the form of a double-acting, two-row axial roller bearing.

The bearing unit may include a massive bearing block, which is connected to a pivot bearing arrangement. Here, pins of the pivot bearing arrangement are directly fastened to the bearing block. In particular, the bearing block is designed to accommodate forces introduced via the spindle drive into the actuating drive. These forces are not introduced via the housing of the actuating drive. Therefore, the actuating drive does not require a supporting external housing. The housing must absorb only minor forces, for example, to support a spindle nut in circumferential direction.

The housing may be pivoted by utilizing pins (also called bearing pins) fastened to the bearing block about an axis, which is located between the drive unit and spindle drive. The outer surfaces of the pins can directly function as bearing surfaces of a roller or slide bearing. In the first case, rolling elements, for example, rollers or needles, directly roll on the pins. Alternatively, it is possible, for example, to press bearing sleeves on the pins.

An alternative embodiment may include an extra slim construction that may be highly resilient in relation to cross-sectional dimensioning. Components of the pivot bearing arrangement, including the pins, and the rotary bearing that supports the shaft may be arranged one behind the other in the bearing block, viewed in axial direction of the spindle drive. In this embodiment, the symmetrical axis of the pins, i.e., the pivoting axis of the pivot bearing arrangement, does not intersect with the rotary bearing, especially the axial roller bearing. The bearing can be adjusted using a preloading device also integrated in the bearing unit. Also viewed in the above-mentioned axial direction, the preloading device may be arranged in one row with the above-mentioned components, so that the pivot bearing arrangement, the rotary bearing and the preloading device are arranged one behind the other.

The column-shaped housing of the actuating drive can be efficiently manufactured from a metal profile, wherein the drive unit, and optionally the associated control electronics, may be situated in the housing. The bearing unit may be adjusted to the internal cross section of the housing. The outer surface of the housing of the actuating drive may be ribbed to allow for easily connecting additional components and to improve heat dissipation.

The pins, with which the pivot bearing arrangement may be implemented, may be designed in the form of hollow pins and screwed into the bearing block. For example, each pin is fastened to the bearing block by means of a screw inserted through the respective pin and countersunk in an opening of the pin. Alternatively, the pins are fastened to the bearing block using riveted joints. In both cases, the bearing block may have a total material thickness measured along the pivoting axis of the pin, which corresponds to more than half of the internal width of the housing measured in the same direction. For example, the bearing block maybe manufactured by machining metal, in particular steel.

If the shaft supported in the bearing unit is formed as a separate connecting shaft coupled with the spindle or as a section of the drive shaft, the connecting shaft or drive shaft and the spindle may be coupled with one another by means of centering contours, which are located directly at the specified parts and especially formed as a combination of the cylindrical pin and the associated drill hole. The connecting shaft or drive shaft has a drill hole, which accommodates a centering pin of the spindle. However, the end of the spindle facing the connecting shaft or drive shaft could also be designed in the form of a hollow cylinder, wherein the connecting shaft or drive shaft may have a pin-shaped centering section, which is inserted in the hollow end of the spindle. Furthermore, it is possible to design the end of the spindle, as well as the end of the shaft, which is connected with the spindle and which faces the spindle, in the form of a hollow cylinder, if both parts to be connected with one another are provided with centering sections. In each case, the shaft supported in the bearing unit may be screwed to the spindle.

In a first embodiment, the preloading device may be designed in the form of a clamping nut, which is arranged at the front end of the bearing block facing the spindle drive. On its outside, the clamping nut is surrounded by a sleeve-like or frame-like section of the bearing block, while a circumferential annular gap is formed between a clamping nut and a connecting shaft on the inner circumference of the clamping nut. If the rotary bearing is designed in the form of a roller bearing, the clamping nut may attach to a bearing ring or bearing plate of the roller bearing. If the rotating bearing is designed in the form of a slide bearing, the preloading device can be designed, for example, to supply a bearing shell with a preload force.

A double-acting axial roller bearing, such as an axial ball bearing, may be used as a roller bearing for supporting the shaft in the bearing block of the bearing unit. A flange of the supported shaft, especially the connecting shaft, is located between two rolling element rows. The flange may ensure that forces can be transferred in axial direction of the bearing and thus also of the entire spindle drive between the bearing block and the supported shaft, if necessary via interposition of the clamping nut. The two rolling element rows of a double-acting axial roller bearing can either roll from a bearing plate, which adjoins the flange, or roll directly on the flange, provided the flange is designed on both sides in the form of a rolling element raceway. Instead of balls, it is also possible to use rollers or needles. The roller bearing supporting the shaft can also be designed in the form of a two-row tilted roller bearing or angular contact ball bearing or a one-row bearing, especially a deep groove ball bearing.

The spindle, which may be screwed together with the connecting shaft or a different shaft supported in the bearing unit, can be secured by using a locking nut. Like the clamping nut, the locking nut is also located on the front end of the bearing block facing the spindle drive. Because of the fact that the locking nut is located in a region radially inside the clamping nut, it is possible that the clamping nut can still be operated after the locking nut has been tightened.

To form a torque-transmitting connection between the drive shaft and the connecting shaft, it may be appropriate to use well-known shaft connections. For example, the drive shaft comprises an outer profile, which may interact in form-fit manner with a corresponding inner profile of the hollow connecting shaft. Outside of this form-fit shaft connection, a housing of the drive unit can be radially connected with the bearing block using several screws.

By means of the bearing unit, two spaces are formed inside the housing of the actuating drive, which may be separated from one another in a sealed manner. In addition to these two spaces, which are arranged one behind the other in axial direction of the actuating drive, there may be a third space disposed at a distance from the center axis of the actuating drive and extending along the entire housing. Components, which are located in the third space, may be connected by at least one wire with electrical components of the drive unit. Therefore, the third space and the space in which the drive unit is located are referred to as subspaces of a single electrical compartment in the housing of the actuating drive. In contrast to the electrical compartment, in the space in which the spindle drive is arranged there may be no parts supplied with electrical power for any intended operation. The space in which the spindle drive is located may also be referred to as a technical equipment chamber. The space in which the drive unit is located may also be referred to as main electrical space, and the additional space connected with the main electrical space may be called a secondary electrical space. In the secondary electrical space, there is at least one sensor component which interacts with the drive unit, as well as with a component of the spindle drive, especially a component of a positioning system.

When installing the actuating drive, the electrical and mechanical main components, i.e., the drive unit, bearing unit and spindle drive, may be pre-assembled, so as to be able to insert them into the housing as a complete structural unit. For example, the spindle drive can be designed in the form of a ball screw drive, a simple motion screw thread or a planetary roller gear. If necessary, components to be mounted in the secondary electrical space, especially sensor components, may be installed separately. The pins of the pivot bearing arrangement can be fastened to the bearing block before or after assembling the secondary electrical space.

1. If a separate connecting shaft is provided between drive unit and spindle drive, the installation of the actuating drive can be performed according to the following steps:

2. A bearing unit, in which a connecting shaft is supported, is provided,

3. the connecting shaft is firmly connected with a spindle of a spindle drive,

4. on the side facing away from the spindle drive, a drive unit is connected to the bearing unit,

5. the arrangement formed by the drive unit, bearing unit and spindle drive is inserted into the housing,

6. through openings in a wall of the housing pins, which function as pivot bearing arrangement, are directly fastened to the bearing unit.

Steps 2 and 3 can be performed in any sequence. If the drive shaft or the spindle is directly supported in the bearing unit, the arrangement, which comprises the drive unit or spindle drive in addition to the bearing unit, may be connected to the missing component, i.e., the spindle drive or the drive unit, before the completed arrangement is inserted in the housing, as provided in step 4. When the pins are fastened to the bearing unit, the housing may not be adjusted. For repair and maintenance purposes, the actuating drive can be easily disassembled in an analogous manner, wherein all the pins must first be removed from the bearing unit. Covers made from plastic materials, which seal the internal space of the housing, may be located at the front ends of the housing.

The separation between electrical space and technical equipment chamber inside the housing is accomplished by means of at least one static and one dynamic sealing gasket, respectively. In addition to an electric drive, energized components of the linear actuating drive especially comprise also components of data processing and data lines, including sensor components. For example, it is possible to arrange for at least one Hall sensor in the electrical chamber as sensor for accommodating angular positions and/or rotational movements.

The electric motor, which drives the spindle, can have its own bearing or can be designed as direct drive with rotor, without bearing support. In the latter case, the rotor of the electric motor is rigidly connected via the connecting shaft with the spindle of the spindle drive, while in the first case optionally a compensating coupling is activated between the electric motor and the spindle. In both cases, the rotor of the electric motor is arranged inside the electric chamber, which is separated in a sealed manner from the technical equipment chamber. In contrast to the bearing support of the spindle or connecting shaft described above, which is designed in the form of an axial roller bearing, preferably a slide bearing is provided for supporting a thrust tube, which can be displaced by means of the associated spindle nut and which can be extended from the housing. Here, a slide bearing element inserted in the housing can connect with a cover, which closes the housing at the front end and which is dynamically sealed toward the thrust tube.

In one embodiment, a continuous housing wall that surrounds the electric chamber and the technical equipment chamber of the actuating drive may be formed by a metal profile. Apart from covers at the front ends, the housing of the actuating drive is manufactured in one piece. The covers at the front end can be manufactured from metal, for example, a steel plate, or a material formed by casting and/or a metallic material formed in a machining process, or made from plastic materials.

The drive motor of the actuating drive located in the electric chamber can be combined with a transmission to form a gear motor. For example, the transmission can involve a planetary gear, which allows for a coaxial configuration of drive motor and spindle drive and thus for a slim design of the actuating drive. In embodiments with a direct electrical drive system of the spindle, as well as in embodiments with an intermediate transmission, the shaft feedthrough between electric chamber and technical equipment chamber is the only place on which the electric chamber must be sealed not only statically, but also dynamically.

In an alternative embodiment, all components of the actuating drive located in the electric chamber may be designed to be maintenance-free. Accordingly, a lubrication connection or a plurality of lubrication connections can be found at the second space of the actuating drive. Because of the fact that at least one component of the spindle drive, such as the thrust tube, can be extended from the technical equipment chamber of the actuating drive, the air-filled volume inside the technical equipment chamber fluctuates. For example, a ventilation device of the technical equipment chamber can comprise a diaphragm or a double diaphragm valve. The ventilation device can be integrated in a cover, such as a plastic cover, which seals the housing on the front end, wherein it is spaced radially away from the component, i.e., the thrust rod, of the actuating drive extending from the technical equipment chamber and thus arranged in asymmetrical manner to the spindle drive.

In an alternative embodiment, a comparable ventilation device is not provided at the electric chamber of the actuating device. The dynamic seal between the electric chamber and the technical equipment chamber allows for low pressure differences between both chambers of, for example, up to just a few millibars.

The housing of the actuating drive, manufactured as an extrusion profile or an extruded profile from a light metal alloy may include an outside profile and contours in the interior, which can be used for connecting various components. Connecting contours, such as a centering seat for a limit switch and a receptacle for a circuit board, can be located inside the electric chamber. To perform fixations by means of such receptacles and connecting contours, such as those with T-slots, countersunk screws according to DIN 605 can be used.

The extrusion profile or extruded profile of the actuating drive may have two cross-sectional areas without any overlaps, wherein two hollow spaces, namely the first subspace of the electrical compartment accommodating the electric motor and the technical equipment chamber are located in the first cross-sectional area, while in the second cross-sectional area only the second subspace of the electrical compartment is located i.e., the subspace, which does not house the electric motor but in which at least one sensor component is arranged. The main electrical space is arranged as first subspace in linear extension of the spindle drive, while the second subspace, namely the secondary electrical space, is arranged parallel to the center axis of the spindle drive, extending across the major part of the length of the housing, for example, more than 80% or more than 90% of the length of the housing, in particular across the entire length of the housing.

An alternative embodiment includes a linear actuating drive that can be put together from a pre-assembled structural unit, which comprises a spindle drive with associated bearing unit and drive unit, and a housing, which is designed in the form of a metal profile, wherein a pivot bearing arrangement can be fastened directly to a multi-functional bearing block of the bearing unit, without introducing forces in the housing. For example, via a bearing stress a power flow can be produced into the bearing unit. A partition wall of the housing, which extends in parallel to the center axis of the spindle drive, is defining the second subspace from the first subspace, as well as from the technical equipment chamber. For example, the secondary electrical space can contain the complete sensor technology of a linear, incremental or absolute measuring system, which is designed to detect the position and/or movement of the thrust rod of the actuating drive. Optionally, the sensor system can be part of the stroke control.

The actuating drive may be used outside, for example, as a component for adjusting a solar module, but also for mobile applications, for example in road or rail vehicles.

### BRIEF DESCRIPTION OF THE DRAWINGS

Subsequently, two embodiments of the disclosure are described by means of a drawing. It is shown:

FIG. 1 a perspective, sectional view of a linear actuating drive,

FIG. 2 a sectional view of the actuating drive,

FIG. 3 a detail of the actuating drive in a depiction according to FIG. 2,

FIG. 4 a cross section of a further actuating drive.

Components corresponding to each other or generally acting in the same manner have the same reference numerals in all figures.

The figures show respectively an electrically driven linear actuating drive (on the whole with the reference numeral 1), which generally functions in the manner cited at the start as prior art. If not specifically mentioned, the following description applies to both embodiments.

### DETAILED DESCRIPTION

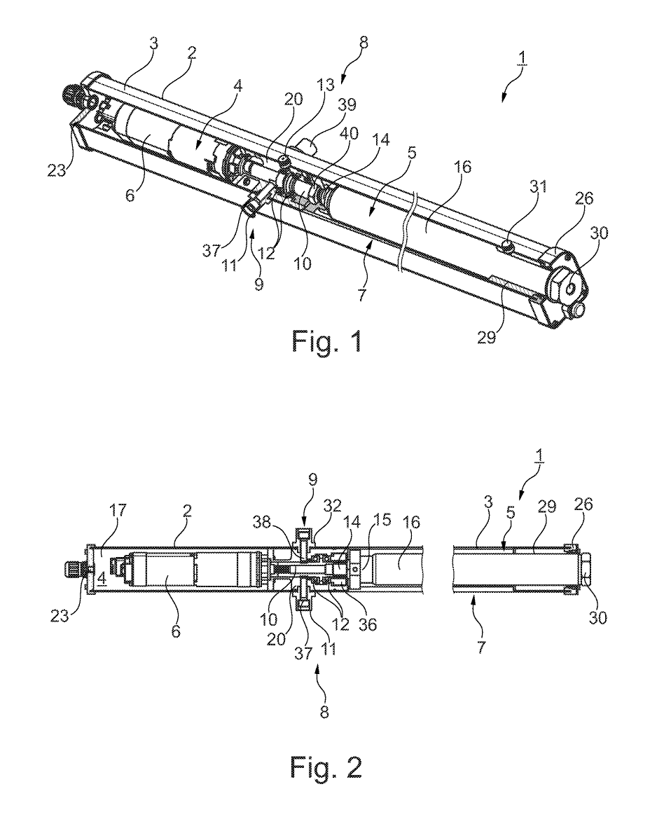

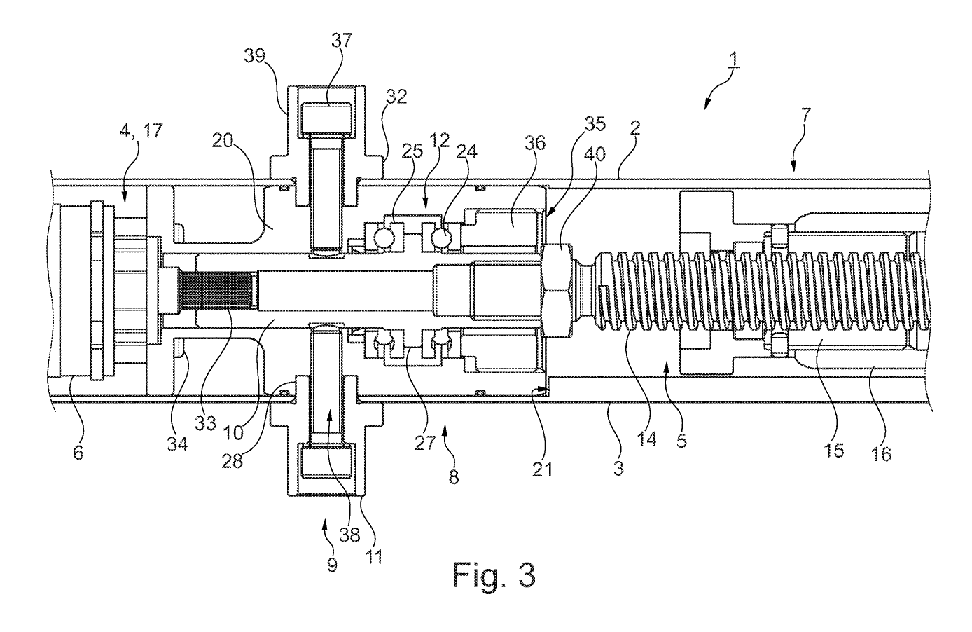

The actuating drive 1 shown in FIGS. 1 to 3 comprises a housing 2, which may have a continuous housing wall 3 formed by a metal profile, which extends almost across the entire length of the actuating drive 1. Inside of the housing 2, there are two separate spaces 4, 5, namely an electrical chamber 4, also called a first space, and a technical equipment chamber 5, also called a second space. The electrical chamber 4 contains energized components, among other things, an electric motor 6. The technical equipment chamber 5 contains a spindle drive 7 powered by the electric motor 6.

At the interface between the electrical chamber 4 and the technical equipment chamber 5, a bearing unit 8 is located in the housing 2, which is sealed toward the housing wall 3 by a static seal (not visible in the figures). The bearing unit 8 is penetrated by a connecting shaft 10, which connects the electric motor 6 with the spindle drive 7 and which is sealed by a dynamic seal toward the bearing unit 8. In the bearing unit 8, the connecting shaft 10 is supported by a roller bearing, namely a double-row axial ball bearing 12. The dynamic seal (not visible) directly adjoins the double-row axial ball bearing 12, wherein it is arranged on the side of the double-row axial ball bearing 12 facing the electrical chamber 4, so that the double-row axial ball bearing 12, which acts in both directions, is located inside the technical equipment chamber 5. For the purpose of re-lubricating the double-row axial ball bearing 12, a lubricant supply 13 in the form of a lubricating nipple is provided. Viewed in axial direction of the spindle drive 7, the lubricant supply 13 is located between both rolling element rows of the axial ball bearing 12.

However, no requirement may be made to re-lubricate components inside the electrical chamber 4. The spindle drive 7 comprises a spindle 14, which may be connected with the connecting shaft 10, and a spindle nut 15. A cladding tube 16, which is also called a thrust tube, may be connected with the spindle nut 15. The cladding tube 16 represents a component of the spindle drive 7 that can be extended from the housing 2.

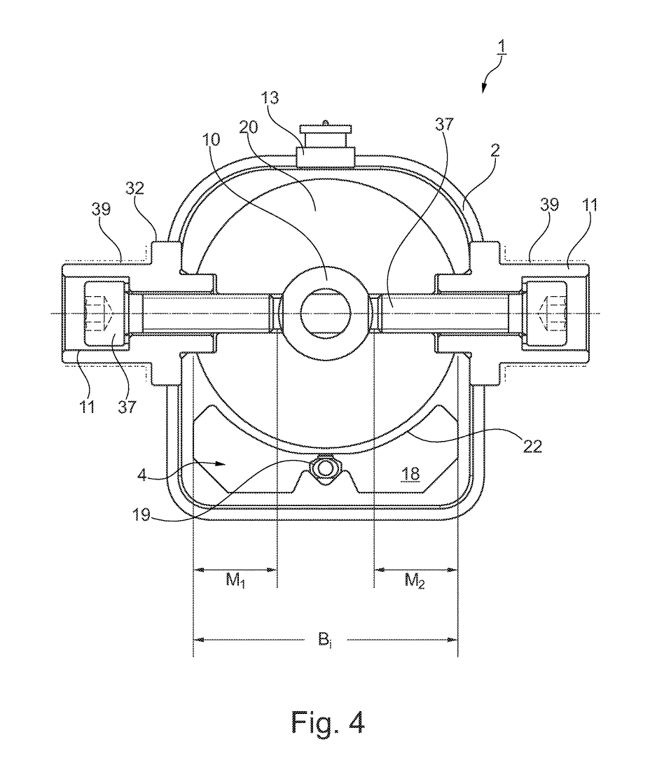

In the embodiment shown in FIG. 4, the electrical chamber 4 is divided in two subspaces 17, 18, namely a main electrical space 17 and a secondary electrical space 18. The main electrical space 17, which without loss of generality is also called an upper electrical space, may have the same profile as the technical equipment chamber 5 and may be located upstream of the technical equipment chamber 5, when viewed in axial direction of the spindle drive 7. In contrast, the secondary electrical space 18, which is also called a lower electrical space, extends across the entire length of the housing 2. A limit switch 19, which may be called a sensory component, can be arranged in the secondary electrical space 18. The limit switch 19 may be designed in the form of a contactless, inductive sensor and interacts with the spindle 15 or a part connected with the spindle nut 15.

Associated electrical lines are also run in the secondary electrical space 18. At the front end of the actuating drive 1, where the electric motor 6 is located, the main electrical space 17 is connected with the secondary electrical space 18 by means of a cable passage (not shown in the cross section) located in a partition wall 22, which separates the secondary electrical space 18 from the technical equipment chamber 5 and the main electrical space 17. The partition wall 22 and the housing wall 3 are formed by a metal profile, from which the housing is manufactured.

In both embodiments, a cover 23 closes the electrical chamber 4 on the front end of the actuating drive 1 on the side of the motor. At the front end of the actuating drive 1 at which the cladding tube 16, which is also called thrust tube, protrudes from the housing 2, the housing 2 is closed with cover 26, wherein the cladding tube 16 is sealed toward the cover 26 by means of seals (not shown). The cover 26 may close the technical equipment chamber 5 and the secondary electrical space 18, if available. For guiding the cladding tube 16, a slide bearing element 29 is provided, which directly interacts with the cladding tube 16. The end of the cladding tube 16 protruding from the housing 2 is closed by means of a connecting element 30, to which, for example, an articulated lug can be connected. For re-lubricating the spindle drive 7, a lubricant supply 31 is provided in the region of the slide bearing element 29. The lubricant supply 31 may be formed in accordance with the lubricant supply 13 at the roller bearing 12 and which penetrates the housing 2 and the slide bearing element 29. The slide bearing element 29 directly adjoins the cover 26. To ventilate the technical equipment chamber 5, a ventilation device, or ventilation component, may be integrated in the cover 26.

The bearing unit 8 may include multiple components subsequently described in more detail, which are integrated in a bearing block 20. In the region of the electrical chamber 4, the cross section of the bearing block 20 is adjusted to the internal cross section of the housing 2. Between the electrical chamber 4 and the technical equipment chamber 5, a step 21 is designed in the interior of the housing 2, which adjoins the bearing block 20. In FIG. 4, the components of the roller bearing 12 comprise two rows of rolling elements 24 and a total of four bearing plates 25. At the same time, the two internal bearing plates 25 adjoin a flange 27, which is an integral part of the connecting shaft 10.

On the side of the electric motor 6, generally also called drive unit, a drive shaft 33, which may be identical or connected with the motor shaft of the electric motor 6, protrudes in a form-fitting manner into the hollow connecting shaft 10. The drive unit 6 as a whole is connected to the bearing block 20 by utilizing multiple retaining screws 34.

On the opposite front end of the bearing block 20 facing the spindle drive 7, a preloading device 35 is integrated in the bearing block 20. By utilizing an annular clamping nut 36 surrounding the connecting shaft 10 while maintaining a gap, the preloading device 35 allows for adjusting the preload of the roller bearing 12. The clamping nut 36 directly adjoins one of the bearing plates 25. Actuating contours designed in the form of recesses may allow the clamping nut 36 to be adjusted, even when the spindle drive 7 is already connected with the bearing unit 8.

The spindle 14 may be centered and screwed into the hollow connecting shaft 10. In addition, a locking nut 40 is screwed on the spindle 14 to secure the screw connection between spindle 14 and connecting shaft 10. The outside diameter of the locking nut 40 is not larger than the inner diameter of the clamping nut 36.

By arranging the electric motor 6 in straight extension of the spindle drive 7 and using a continuous one-piece housing 2, the actuating drive 1 as a whole may have a slim and sturdy construction. To be able to support the actuating drive 1 in tilting fashion in an adjacent construction, a pivoting device 9 is provided at the bearing unit 8. Two hollow pins 11 may be mounted directly at the bearing block 20. Each pin 11 describes in cross section a T-form on the side facing the bearing block 20, wherein a T-base 28 is inserted in an opening in the bearing block 20. On the opposite side facing to the outside, the cross section of the pin 11 also has a T-shaped design. A single stud flange 32 of each pin 11 represents the T-headed stud of the T-outline of the pin 11 facing to the inside, as well as the one facing to the outside. In the region of the outer T-outline, the screw head of a screw 37 touches the pin. As a result, the screw 37 is completely countersunk. In the embodiments, the screws 37 are respectively screwed in through holes 38 in the bearing bock 20. However, the bearing block 20 could also have blind holes with appropriate internal threads.

The cylindrical section of each pin 11 protruding from the bearing block 20 may be a bearing surface 39 of a roller or slide bearing. The complete housing 2 or parts of the housing 2 may be retained by the pins 11 at the bearing block 20. The housing 2 represents a mechanically slightly loaded component of the actuating drive 1.

The bearing block 20, on the other hand, may be a central, power absorbing element of the actuating drive 1. The internal width denoted with B₁ may be largely filled with the material of the bearing block: in a cross-section set through the pivoting axis of the pivot bearing arrangement 7, the bearing block 20 has on both sides of the connecting shaft 10 material thickness, which are denoted with M₁ and M₂. The total material thickness M=M₁ and M₂ may amount to more than half the internal width B₁ of the housing 2. This may be used to the embodiment without (FIGS. 1 to 3) the secondary electrical space 18, as well as the embodiment with (FIG. 4) the secondary electrical space 18.

### REFERENCE NUMERALS

1 actuating drive
2 housing
3 housing wall
4 electrical chamber
5 technical equipment chamber
6 electric motor
7 spindle drive
8 bearing unit
9 pivot bearing arrangement
10 connecting shaft
11 pin
12 axial ball bearing
13 lubricant supply
14 spindle
15 spindle nut
16 cladding tube
17 main electrical space
18 secondary electrical space
19 limit switch
20 bearing block
21 step
22 partition wall
23 cover
24 rolling element
25 bearing plate
26 cover
27 flange
28 T-base
29 slide bearing element
30 connecting element
31 lubricant supply
32 stud flange
33 drive shaft
34 retaining screw
35 preloading device
36 clamping nut
37 screw
38 through hole
39 bearing surface
40 locking nut
B₁ internal width
M₁ material thickness
M₂ material thickness
M total material thickness

1. A linear actuating drive, that includes a housing, comprising:
a drive unit including a drive shaft;
a spindle drive that includes a spindle and is configured to be actuated by the drive shaft;
a bearing unit arranged between the drive unit and the spindle drive and configured to support a shaft that is connected with the drive shaft and the spindle;
wherein the bearing unit includes a bearing block directly fastened to pins and configured to accommodate forces introduced into the spindle drive.

2. The linear actuating drive of claim 1, wherein the bearing block includes a total material thickness along a pivoting axis of the pins that corresponds to more than half of an internal width of the housing measured in the same direction.

3. The linear actuating claim 1, wherein the pins are hollow and screwed into the bearing block.

4. The linear actuating drive of claim 3, wherein the pins are fastened to the bearing block utilizing a screw inserted through a respective pin and countersunk in an opening of one of the pins.

5. The linear actuating drive of claim 2, wherein the pins are fastened to the bearing block using riveted joints.

6. The linear actuating drive of claim 5, wherein outer surfaces of the pins are designed to function as bearing surfaces.

7. (canceled)

8. The linear actuating drive of claim 1, wherein the actuating drive includes a preloading device that includes a clamping nut that is concentric to a supporting shaft.

9. The linear actuating drive of claim 1, wherein the housing includes an internal space with a first and second cross-section area separated by a partition wall, wherein the first cross-section area includes the drive unit, the bearing unit, and the spindle drive, and the second cross-sectional area extends across an entire length of the housing and includes one or more sensor components configured to interact with the drive unit and a component of the spindle drive.

10. A method for assembling a linear actuating drive, comprising the following steps:
providing a bearing unit that includes a connecting shaft;
connecting the connecting shaft to a spindle of a spindle drive;
connecting a drive unit to the bearing unit on a side facing away from the spindle drive;
inserting the drive unit, bearing unit, and spindle driving into a housing;
fastening pins to the bearing unit through openings in a wall of the housing.

11. An actuating drive comprising:
a drive unit including a drive shaft;
a spindle drive that includes a spindle configured to be actuated by the drive shaft;
a bearing unit arranged between the drive unit and a spindle drive, wherein the bearing unit is configured to support a shaft that is connected to the drive shaft and the spindle; and
a first and second chamber, wherein the first and second chamber are separated by the bearing unit and formed inside a housing of the actuating drive.

12. The actuating drive of claim 11, wherein the first chamber is a technical equipment chamber that includes the spindle drive.

13. The actuating drive of claim 11, wherein the first and second chamber are further separated by utilizing at least one static and one dynamic sealing gasket.

14. The actuating drive of claim 11, wherein the first chamber is an electrical chamber that includes a sensor configured to accommodate angular positions of the actuating drive.

15. The actuating drive of claim 11, wherein the first chamber is an electrical chamber that includes a sensor configured to accommodate rotational movement of the actuating drive.

16. The actuating drive of claim 11, wherein the bearing unit includes a roller bearing configured to support the shaft.

17. The actuating drive of claim 1, wherein the actuating drive includes a lubricant supply configured to lubricate the spindle drive.

18. The actuating drive of claim 11, wherein the bearing unit includes a pivoting device including two pins mounted at a bearing block.

19. The actuating drive of claim 11, wherein the actuating drive includes a cover that includes a ventilation device configured to ventilate a chamber of the actuating drive.

20. The actuating drive of claim 11, wherein the actuating drive further includes a motor configured to actuate the drive shaft.
